(19) United States
(12) Patent Application Publication
(10) Pub. No.: US 2013/0275206 A1
(43) Pub. Date: Oct. 17, 2013

(54) PER COLO DISTRIBUTION IN ONLINE ADVERTISING

(71) Applicant: Ajay Shekhawat, San Francisco, CA (US)

(72) Inventor: Ajay Shekhawat, San Francisco, CA (US)

(73) Assignee: Yahoo! Inc., Sunnyvale, CA (US)

(21) Appl. No.: 13/444,268

(22) Filed: Apr. 11, 2012

(51) Int. Cl. G06Q 30/02

(52) U.S. Cl. 705/14.43

(57) ABSTRACT

Techniques are provided that utilize online advertising traffic patterns at multiple geographically distributed data centers to make predictions about future traffic at the data centers, and use the predicted patterns in optimizing proportioning or allocation of an advertising budget between each of the data centers. For each of multiple geographically distributed data centers, a set of traffic data may be obtained, relating to past online advertising traffic at the data center. For each of the data centers, the set of traffic data is used in determining a prediction of online advertising traffic at the data center of a future period of time, which may include determining and utilizing a traffic pattern function for the data center. Using the prediction for each of the data centers, an optimized allocation is performed of an advertiser's online advertising budget over a future period of time between each of the data centers.

### BACKGROUND

An online advertiser may utilize an online advertising budget over a period of time that may span advertising that may be serviced by different data centers, collocations, or cobs, such as advertising in different geographic regions serviced by different data centers. However, the budget may be insufficiently or not satisfactorily optimized, such as with regard to allocation between various data centers. This can lead to problems, such as undesirable spikes or dips in spend, overly fast or slow use of spend over particular periods, premature or incomplete use of a spend over a period of time, etc., which can ultimately lead to inefficiently and decreased ROI.

### SUMMARY

Some embodiments of the invention provide systems and methods for use in online advertising. In some embodiments, techniques are provided that utilize online advertising traffic patterns at multiple geographically distributed data centers to make predictions about future traffic at the data centers, and use the predicted patterns in optimizing proportioning or allocation of an advertising budget between each of the data centers. For each of multiple geographically distributed data centers, a set of traffic data may be obtained, relating to past online advertising traffic at the data center. For each of the data centers, the set of traffic data is used in determining a prediction of online advertising traffic at the data center of a future period of time, which may include determining and utilizing a traffic pattern function for the data center. Using the prediction for each of the data centers, an optimized allocation is performed of an advertiser's online advertising budget over a future period of time between each of the data centers.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

Herein, the term “advertiser” broadly includes advertisers as well as their proxies, agents, etc.

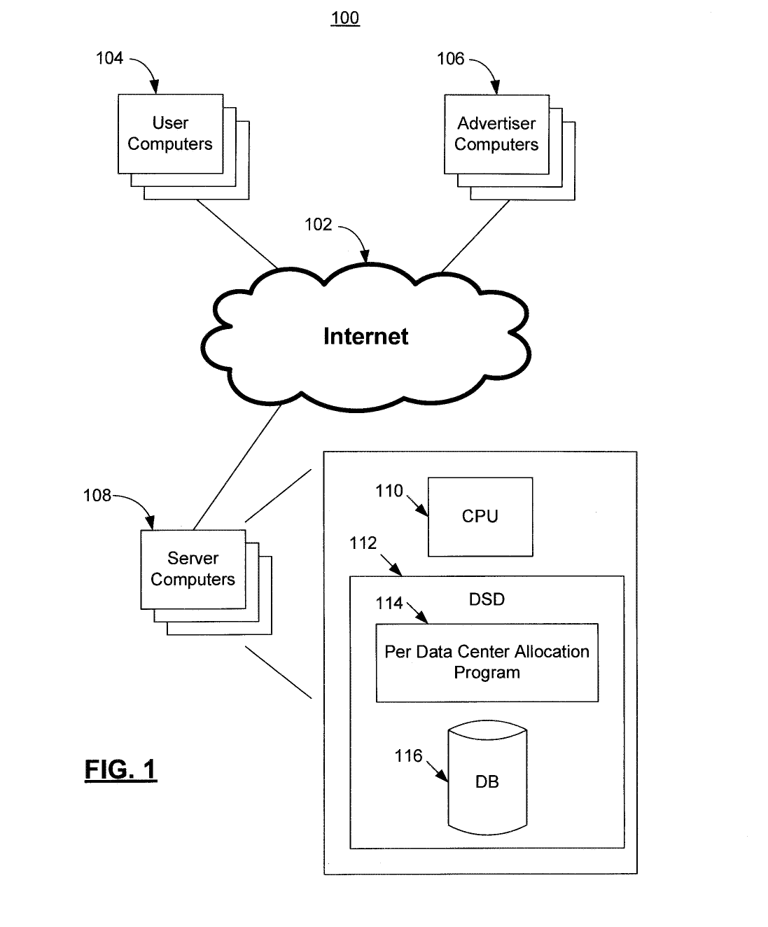

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks WANs, LANs, telephone, cell phone, or other data networks, etc. The invention further contemplates embodiments in which user computers or other computers may be or include wireless, portable, or handheld devices such as cell phones, smart phone, PDAs, tablets, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, coupon-related advertisements, group-related advertisements, social networking-related advertisements, etc.

As depicted, each of the server computers 108 includes one or more CPUs 110 and a data storage device 112. The data storage device 112 includes a database 116 and a Per Data Center Allocation Program 114.

The Program 114 is intended to broadly include all programming, applications, algorithms, software, engines, modules, functions and other tools necessary to implement or facilitate methods and systems according to embodiments of the invention. The elements of the Program 114 may exist on a single server computer or be distributed among multiple computers or devices.

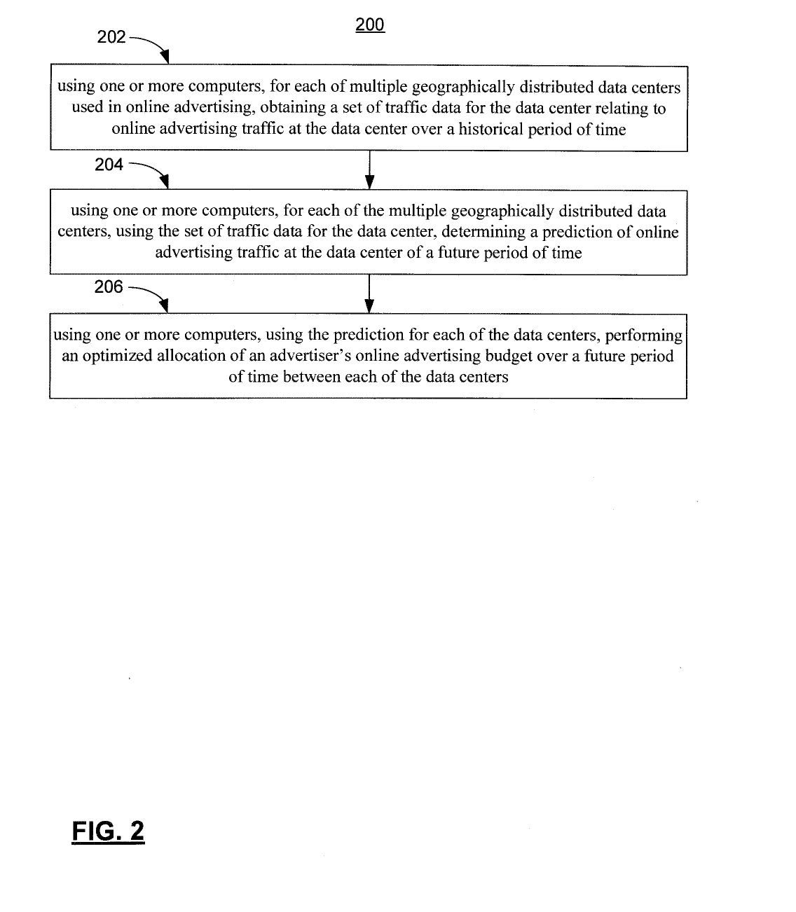

FIG. 2 is a flow diagram illustrating a method 200 according to one embodiment of the invention. Step 202 includes, using one or more computers, for each of multiple geographically distributed data centers used in online advertising, obtaining a set of traffic data for the data center relating to online advertising traffic at the data center over a historical period of time.

Step 404 includes, using one or more computers, for each of the multiple geographically distributed data centers, using the set of traffic data for the data center, determining a prediction of online advertising traffic at the data center of a future period of time.

Step 206 includes, using one or more computers, using the prediction for each of the data centers, performing an optimized allocation of an advertiser's online advertising budget over a future period of time between each of the data centers.

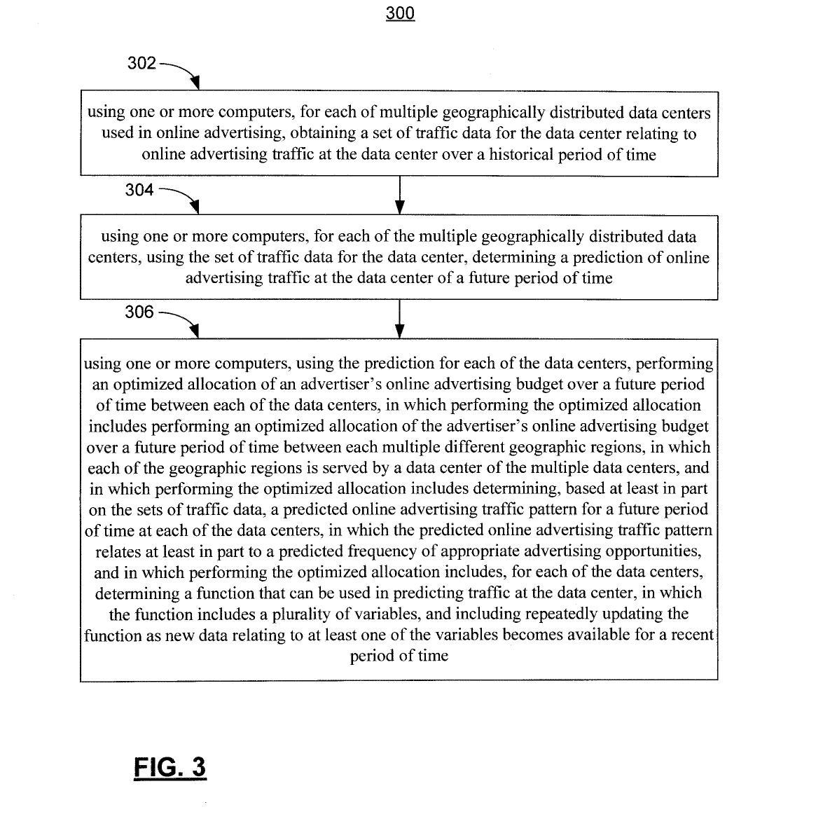

FIG. 3 is a flow diagram illustrating a method 300 according to one embodiment of the invention. Steps 302 and 304 are similar to steps 202 and 204 as depicted in FIG. 2.

Step 306 includes, using one or more computers, using the prediction for each of the data centers, performing an optimized allocation of an advertiser's online advertising budget over a future period of time between each of the data centers. Performing the optimized allocation includes performing an optimized allocation of the advertiser's online advertising budget over a future period of time between each multiple different geographic regions, in which each of the geographic regions is served by a data center of the multiple data centers. Furthermore, performing the optimized allocation includes determining, based at least in part on the sets of traffic data, a predicted online advertising traffic pattern for a future period of time at each of the data centers, in which the predicted online advertising traffic pattern relates at least in part to a predicted frequency of appropriate advertising opportunities. Still further, performing the optimized allocation includes, for each of the data centers, determining a function that can be used in predicting traffic at the data center, in which the function includes a plurality of variables, and including repeatedly updating the function as new data relating to at least one of the variables becomes available for a recent period of time.

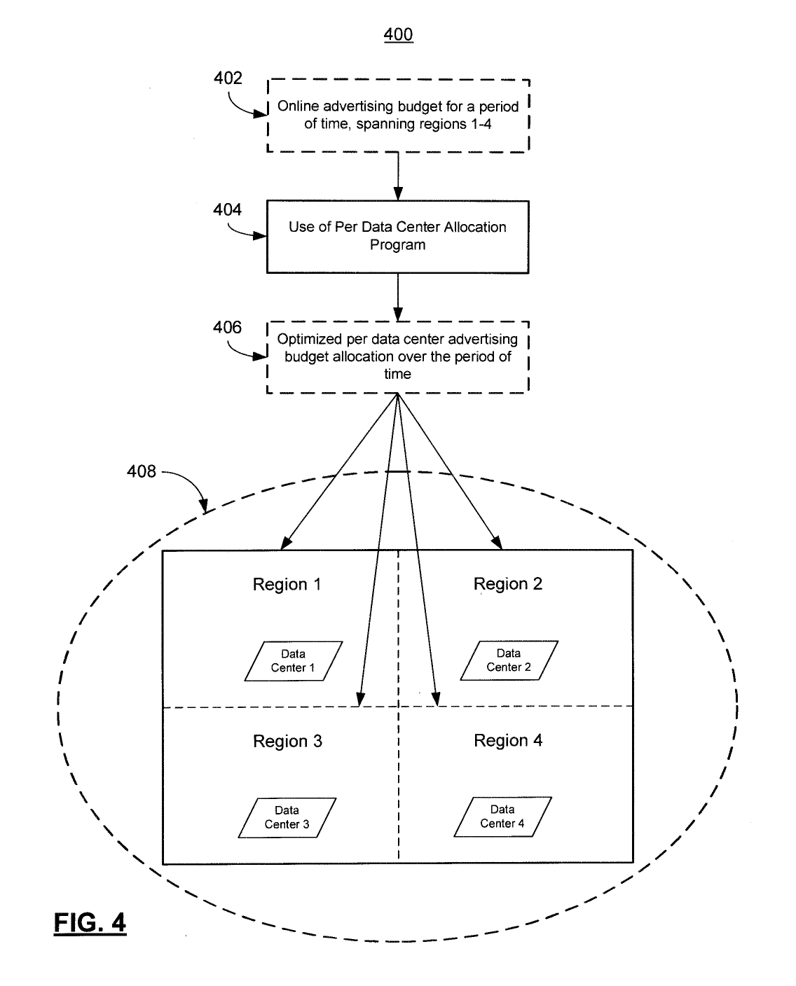

FIG. 4 is a block diagram 400 illustrating one embodiment of the invention. Block 402 represents an online advertising budget for a period of time, spanning a large overall region containing regions 1-4. The budget, and other information, is used as input to the Per Data Center Allocation Program 404, according to one embodiment of the invention.

The Program 404 outputs, as represented by block 406, an optimized per data center advertising budget allocation over the period of time, which can include various parameters, relating to budget allocation over each of depicted regions 1-4, each served by a different data center, including data centers 1-4.

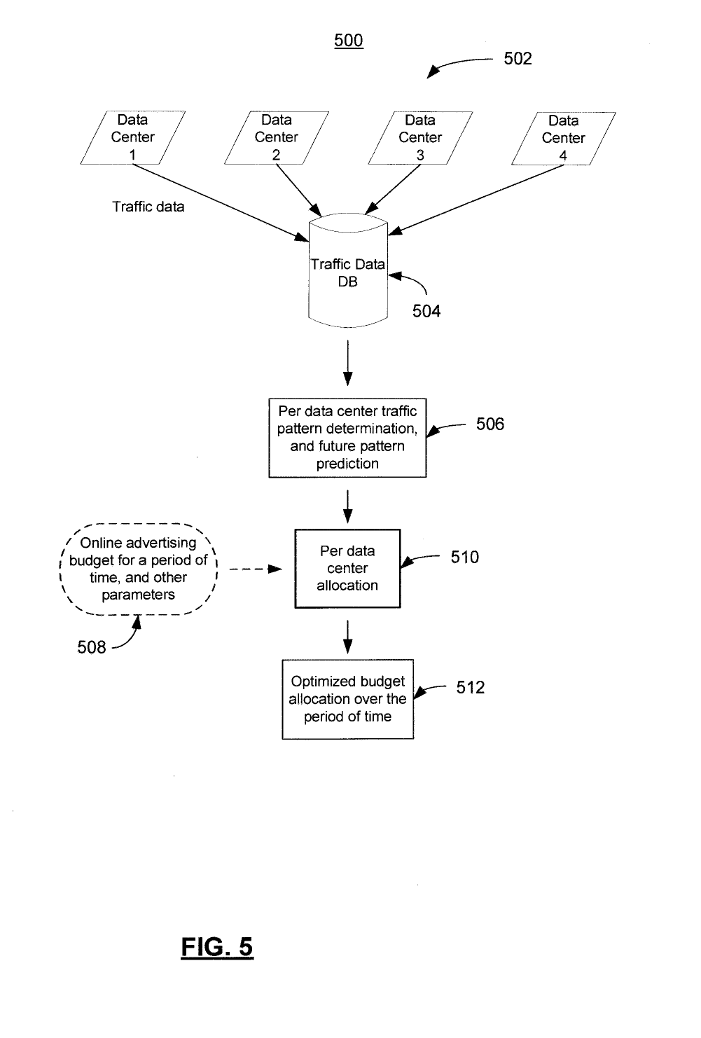

FIG. 5 is a block diagram 500 illustrating one embodiment of the invention. As depicted, data centers 1-4 502 send traffic data, relating to the traffic center, to a traffic data database 504. Various elements depicted in FIG. 5 may be accomplished by a Per Data Center Allocation Program, according to an embodiment of the invention.

Block 506 represents per data center traffic pattern determination, and per data center future traffic pattern prediction or forecasting, which may be based at least in part on the determined traffic patterns.

As represented by block 510, per data center allocation is performed, using input information including an online advertising budget, over regions covered by different data centers, over a period of time. Various other parameters may also be input, such as advertising information, targeting parameters, etc.

Block 512 represents an output optimized budget allocation over a period of time, which allocation may include various specified or quantified parameters, and may include proportioning of the budget over each of the data centers or regions, as well as other information. Of course, the Per Data Center Allocation Program may be part of or integrated with other or larger programs which may include optimization based on other parameters, etc.

In online advertising, an advertiser's campaign, over a period time, can span multiple geographic regions, or be global. Typically, a geographic region is served (using the term “served” in a broad sense), or best or most efficiently served, by one or more data centers, or colos, that may be within or near to the geographic region served. Although geographic regions are generally referenced, other types or not strictly geographic regioning or divisioning is also possible.

For example, one or more data centers in a particular geographic region may be used in operations that may include advertisement selection, targeting and serving in connection with serving opportunities, or appropriate serving opportunities to users who may be within the geographic region, for example. Online advertising traffic experienced by a particular data centers, such as may include frequency of online advertising serving opportunities, or certain such opportunities, may influence an online advertising campaign in that region. For example, a rate of spend for an advertising campaign may be higher in a region during periods of higher traffic.

Since a multi-region online advertising campaign may, for example, be subject to a particular budget or budget range during a period of time, it can be important that spend is used at an appropriate or optimized rate or allocated in an optimized way. For example, an advertiser may desire that, or a campaign may be most efficient or profitable if, spend is spread out between each of a number of regions, such as smoothly spread out, or possibly spread out in any of various ways, such as by utilizing particular percentages or percentage ranges of spend in particular regions, emphasizing or increasing spend in more profitable regions, etc.

For these and other reasons, it can be important to predict a campaign's spend rate over a future period of time in a particular region, such as over a future hour or set of hours. One simplistic way to do this is to determine spend rate over a previous hour or time period, and use that as an estimation of a spend rate over a future period. However, such a simplistic approach can have many problems, such as by utilizing stale data, such as data from several hours ago, or by changes, such as sharp changes, from period to period, and can have many other problems. For example, traffic, and spend rate, over hours in the middle of the night in a particular region may be very different from hours in the daytime, or from hour to hour, or even from weekend to weekday, holiday from non-holiday, or from other non-calendar based changes, etc. As such, as a simple example, for a global advertising campaign spanning different time zones over a period of 24 hours, for example, traffic in some regions will be at 6 am and may be low, traffic at 6 pm in other regions may be high, etc. Without accurate predictions, this can lead to under spending or too slow spending in one regions, over spending or too fast spending in another region, etc. Of course, patterns depend on many other factors, and this is just a very simple example.

Non-optimized allocation or distribution of an advertiser's budget over multiple regions, served by different data centers, can lead to problems such as inefficiently or suboptimally spending too fast and running out of spend for the remainder of a time period in a region or over regions, spending too slow and inefficiently or suboptimally not spending all or most of a desired amount, etc. Conversely, accurate, proper, or better optimized allocation can allow greater efficiency, smoothness, profitability, geographic range of coverage, etc.

Some embodiments of the invention allow budget allocation, or optimized allocation, based at least in part on predicted or forecasted traffic on a per data center basis. For example, in some embodiments, it is noted that traffic (or certain traffic or types of traffic) at a data center can correlate with, or otherwise be used to anticipate, estimate, predict, forecast, or determine, spend or spend rate over a particular period of time in a region served by the data center for a particular online advertising campaign. Furthermore, in some embodiments, past, or historical, traffic data relating to a data center can be used to determine traffic patterns over time at the data center. These patterns can then be used in predicting or forecasting traffic, or certain traffic or types of traffic, at the data center over a future period of time. In some embodiments, functions may be determined or derived and used in determining patterns or predictions. These predictions can be used, for example, in performing an optimized allocation or distribution of an advertising budget, such as over multiple data centers or multiple regions served by different data centers. This, in turn, can lead to better planned, better optimized, more efficient, more advertiser-satisfying, or more profitable use of an online advertising budget.

In some embodiments, any of a number of techniques, such as models, machine learning techniques, programs, algorithms, applications, software, engines, modules, functions, etc., may be used in aspects of implementation. Such aspects can include analyzing past data center traffic patterns to predict or forecast future traffic patterns, and analyzing predictions of traffic to determine optimized online advertising budget allocation between data centers or regions served by different data centers, determining and utilizing per data center functions, of multiple variables, in determining per data center patterns over future periods of time, where quantities for variables may be determined from past data, estimated in cases where insufficient or no data is available, etc.

As such, some embodiments of the invention utilize per data center budget allocation or distribution based on information including historical data as well as determined patterns and predictions on a per data center basis. For example, in a globally distributed advertising system, spread out over several data centers, it can be a challenge to allocate the budgets to each data center in an optimized fashion. For example, at a given time, some areas receive a lot of traffic, and some don't. If a budget is not allocated or distributed in an optimized fashion, some regions run out of budgets, while others will leave their budgets unspent. Some embodiments of the invention provide techniques that determine and take into account historical traffic patterns, such as in order to allocate budget between different data centers in a more efficient manner.

Some embodiments include a recognition that, given, for example, an advertisement campaign with a particular advertisement and with an associated budget and a network of globally-distributed data centers from which this advertisement could be served, a system or serving system may need to devise an optimal strategy to allocate the budget to the data centers efficiently. In some known techniques, budget portions may be allocated for fixed time intervals in the future, such as the next hour, or maybe the next several hours. If a budget portion is allocated to a data center which does not get much traffic at that time of the day (or day of the week), for example, then the budget can go unspent. Some embodiments of the invention provide or are used in providing an optimized budget allocation strategy for a globally distributed serving system.

In some embodiments, an expected spend pattern for the upcoming time period for a data center is derived. This may be function of several variables, such as, potentially among many other things, the time period in question, the geolocation of the data center, the geo and demographic targeting attributes of the advertisement or campaign in question, the day of the week, the budget spent in the previous time period, the spend on the previous day at the same time, the spend on the previous week at the same time, whether it's a holiday at that location, and the spend on the same day and time in the previous year. Similar calculations may be done in a hierarchical manner for entities higher in the hierarchy. Not all of these quantities will be available, and default or estimated quantities may be used for the unknown ones. In some embodiments, these may all be combined into a function that is used to predict the expected traffic at the data center in the upcoming time period. In some embodiments, this function may be continuously, periodically or repeatedly updated as the data for previous time periods comes in.

Once predicted spend patterns for each data center are determined, based at least in part on budget, which may be specified by the advertiser, determinations can be made so that the budget can be allocated distributed or divided in a proportional, desired or optimized manner.

While the invention is described with reference to the above drawings, the drawings are intended to be illustrative, and the invention contemplates other embodiments within the spirit of the invention.

1. A method comprising:
using one or more computers, for each of a plurality of geographically distributed data centers used in online advertising, obtaining a set of traffic data for the data center relating to online advertising traffic at the data center over a historical period of time;
using one or more computers, for each of the plurality of geographically distributed data centers, using the set of traffic data for the data center, determining a prediction of online advertising traffic at the data center of a future period of time; and
using one or more computers, using the prediction for each of the data centers, performing an optimized allocation of an advertiser's online advertising budget over a future period of time between each of the data centers.

2. The method of claim 1, wherein performing the optimized allocation comprises performing an optimized allocation of the advertiser's online advertising budget over a future period of time between each of a plurality of different geographic regions, wherein each of the geographic regions is served by a data center of the plurality of data centers.

3. The method of claim 1, wherein performing the optimized allocation comprises optimally proportioning budgetary spend between each of the plurality of data centers.

4. The method of claim 1, wherein performing the optimized allocation comprises determining, based at least in part on the sets of traffic data, a predicted online advertising traffic pattern for a future period of time at each of the data centers.

5. The method of claim 1, wherein performing the optimized allocation comprises determining, based at least in part on the sets of traffic data, a predicted online advertising traffic pattern for a future period of time at each of the data centers, wherein the predicted online advertising traffic pattern relates at least in part to a predicted frequency of appropriate advertising opportunities.

6. The method of claim 1, wherein performing the optimized allocation comprises allocating spend between the data centers such that a desired distribution of spend between the data centers is achieved or likely to be achieved.

7. The method of claim 1, wherein performing the optimized allocation comprises allocating spend between the data centers such that a desired spend rate over a period of time is achieved or likely to be achieved.

8. The method of claim 1, wherein performing the optimized allocation comprises allocating spend between the data centers such that a desired spend rate is achieved or likely to be achieved which is designed to allow, over a period of time spanning usage of each of the data centers, avoiding overly fast budget depletion and avoiding overly slow budget depletion.

9. The method of claim 1, wherein performing the optimized allocation comprises, for each of the data centers, determining a function that can be used in predicting traffic at the data center, wherein the function includes a plurality of variables.

10. The method of claim 1, wherein performing the optimized allocation comprises, for each of the data centers, determining a function that can be used in predicting traffic at the data center, wherein the function includes a plurality of variables, and comprising repeatedly updating the function as new data relating to at least one of the variables becomes available for a recent period of time.

12. The method of claim 1, wherein using one or more computers comprises using one or more server computers.

13. The method of claim 1, wherein performing the method comprises using one or more software engines.

14. The method of claim 1, wherein performing the method comprises using one or more software modules.

15. A system comprising:
one or more server computers coupled to a network; and
one or more databases coupled to the one or more server computers;
wherein the one or more server computers are for:
for each of a plurality of geographically distributed data centers used in online advertising, obtaining a set of traffic data for the data center relating to online advertising traffic at the data center over a historical period of time;
for each of the plurality of geographically distributed data centers, using the set of traffic data for the data center, determining a prediction of online advertising traffic at the data center of a future period of time; and
using the prediction for each of the data centers, performing an optimized allocation of an advertiser's online advertising budget over a future period of time between each of the data centers.

16. The system of claim 15, wherein at least one of the one or more server computers are coupled to the Internet.

17. The system of claim 15, wherein performing the optimized allocation comprises performing an optimized allocation of the advertiser's online advertising budget over a future period of time between each of a plurality of different geographic regions, wherein each of the geographic regions is served by a data center of the plurality of data centers.

18. The system of claim 15, wherein performing the optimized allocation comprises determining, based at least in part on the sets of traffic data, a predicted online advertising traffic pattern for a future period of time at each of the data centers.

19. The system of claim 15, wherein performing the optimized allocation comprises determining, based at least in part on the sets of traffic data, a predicted online advertising traffic pattern for a future period of time at each of the data centers, wherein the predicted online advertising traffic pattern relates at least in part to a predicted frequency of appropriate advertising opportunities.

20. A computer readable medium or media containing instructions for executing a method comprising:
using one or more computers, for each of a plurality of geographically distributed data centers used in online advertising, obtaining a set of traffic data for the data center relating to online advertising traffic at the data center over a historical period of time;
using one or more computers, for each of the plurality of geographically distributed data centers, using the set of traffic data for the data center, determining a prediction of online advertising traffic at the data center of a future period of time; and
using one or more computers, using the prediction for each of the data centers, performing an optimized allocation of an advertiser's online advertising budget over a future period of time between each of the data centers,
wherein performing the optimized allocation comprises performing an optimized allocation of the advertiser's online advertising budget over a future period of time between each of a plurality of different geographic regions, wherein each of the geographic regions is served by a data center of the plurality of data centers;
wherein performing the optimized allocation comprises determining, based at least in part on the sets of traffic data, a predicted online advertising traffic pattern for a future period of time at each of the data centers, wherein the predicted online advertising traffic pattern relates at least in part to a predicted frequency of appropriate advertising opportunities; and
wherein performing the optimized allocation comprises, for each of the data centers, determining a function that can be used in predicting traffic at the data center, wherein the function includes a plurality of variables, and comprising repeatedly updating the function as new data relating to at least one of the variables becomes available for a recent period of time.
